(19) United States
(12) Patent Application Publication
(10) Pub. No.: US 2004/0261938 A1
(43) Pub. Date: Dec. 30, 2004

(54) Process for making a 3D picture frame

(76) Inventor: Richard N. Bradford, Longwood, FL (US)

Correspondence Address: William M. Hobby, III, Suite 375, 157 E. New England Avenue, Winter Park, FL, 32789, US

(21) Appl. No.: 10/841,345

(22) Filed: May 10, 2004

Related U.S. Application Data
(63) Continuation-in-part of application No. 29/185,141, filed on Jun. 24, 2003, now Pat. No. D491374.

(51) Int. Cl. B32B 31/00; G09F 11/00; C09J 1/00

(52) U.S. Cl. 156/247; 156/256; 156/64; 156/267; 156/272.8

(57) ABSTRACT

A process of making a picture frame having an irregular 3D border artwork surrounding a picture window includes the steps of selecting a plurality of images and making lenticular 3D look border art for the frame. A cut path is marked in a computer for cutting the inner and outer irregular borders in the frame lenticular front panel and the rear panel and the front and rear panels are then cut with a laser cutter around the border artwork. The cutout window is removed and a transparent window cover is attached over the window. The front and rear panel area attached together leaving a 3D border image around a window having a transparent window cover.

### BACKGROUND OF THE INVENTION

This patent application is a continuation-in-part of my pending U.S. patent application No. 29/185,141 filed Jun. 24, 2003 for Process for Making a Picture Frame.

The present invention relates to a process of making a picture frame with a three dimensional look (3D) picture frame and especially to a process of making a 3D picture frame having a decorative border around a center window for mounting a photo or the like.

In the past, it has been common to make a wide variety of picture frames. A typical picture frame is formed having an edge molding having a rectangular shape with mitered corners and having a sheet of transparent glass or plastic, such as an acrylic sheet, mounted under an edge lip on the molding. A mat is positioned under the transparent sheet of glass having a cutout center portion for mounting artwork. Usually a non-porous backing and a stiff backing are positioned behind the artwork within the frame molding. The glass, mat, artwork, and backing can be held in place within the molding using small nails or the like to hold the framed artwork together. A hanger is typically added to the frame which may consist of screw eyes on two sides of the edge molding connected by a hanging wire.

The prior art also includes the use of picture frames made out of acrylic sheets which have had screen printed images on one side of the acrylic sheet. The image is printed to form a border having a transparent center portion where the print can be mounted. This becomes very labor intensive because printing each of the colors in the design requires that the acrylic sheet be passed through the press another time. Designs can also be screen printed onto an acrylic sheet. The screen printing does not produce the fine details in the print and to obtain finer detail requires much more expensive screen printing which still does not produce the fine details produced in off-set printing. This procedure can be utilized for printing solid borders onto an acrylic sheet having a transparent center portion for mounting a picture adjacent thereto for viewing from the other side of the sheet. Decorative frames can also be made using an acrylic sheet having border artwork offset printed onto a piece of paper which is then die cut to the shaped specifications. The die cut printed paper is slid into a clear acrylic frame. This tends to look cheap and unappealing to customers and, in addition, custom dies for custom shapes increases the cost of making the plastic picture frame. In any process, it is also desirable to mount a frame easel or hanger on the back of the acrylic picture frame in order to support the picture frame on a desk or to hang the picture frame on a wall or surface.

My prior U.S. Pat. No. 6,402,878 of Jun. 11, 2002, covers a process for making a picture frame with border artwork. Border artwork is printed on a sheet of material and attached to a transparent panel which is laser cut to conform to the border artwork. The border artwork is zone coated with an adhesive over the printed artwork and attached to the transparent sheet of material so that cutting the printed sheet along the marked cut inside path forms a cutout of the printed sheet which is removed to provide a transparent window for viewing a picture placed therein. The process includes folding the polymer sheet and attaching a frame stand thereto. My prior U.S. Pat. No. 6,395,125 of May 28, 2002 is for a process for making a picture frame which includes the steps of printing border artwork on a transparent sheet of material leaving a transparent center window and making an outer cut path for the printed transparent sheet. The printed transparent sheet is coated with an adhesive and attached to a transparent polymer member which is cut along an outer cut path to form an exterior border edge.

Photosteroscopic lenticular images have been in wide use in recent years and provide a three dimensional (or 3D image) without the use of a steroscopic viewers or the use of special glasses, so that each eye of a person views a slightly different image. Lenticular 3D images are formed using lenticular sheets of plastic which have a plurality of elongated lenses or prisms formed thereon. Underneath the lenticular sheet are two or more images broken up into a plurality of thin columns which are interleaved to form a composite image. When the interleaved composite image is placed beneath a lenticular sheet, the lens refract the light differently for each spaced column so that each eye of the view is constantly viewing one of the interleaved images separately from the other eye viewing the other image to create a three dimensional lenticular image without the use of a separate viewing apparatus.

The present invention is an improvement over my prior patents and is a process for making a picture frame having decorative 3D border around a window.

The present process is for making a laminated plastic picture frame having a 3D decorative border which can be made in any desired shape. The high quality 3D print is laminated onto a plastic frame without the use of expensive die charges such that small runs are economically feasible while also allowing fast and large production runs.

### SUMMARY OF THE INVENTION

A process of making a picture frame having a 3D look border artwork includes the steps of selecting a plurality of images for making a 3D border artwork including dividing each selected image into a plurality of image components and interleaving each image's components to form a composite border image of two interleaved images for 3D viewing through a lenticular sheet. The composite image is applied to a lenticular sheet to thereby form a 3D border image. A cut path is marked in a computer for cutting the inner and outer irregular borders in the composite image and lenticular sheet and forming a cut path in a computer for cutting a back panel for the picture frame. The lenticular sheet and composite image are laser cut along the computer marked cut path along the inner and outer irregular borders of the 3D border image to form a window through the lenticular sheet inside the 3D border image. The cutout window is removed and a transparent window cover formed of a thin polymer sheet is attached over the window to the lenticular sheet. The frame back is laser cut and attached to the lenticular sheet of material over the 3D border image and transparent window cover to form a picture frame with a 3D decorative border. The composite image may be printed directly on the lenticular sheet or onto a separate sheet of material which is adhesively attached to the back of the lenticular sheet. A backing polymer sheet may be attached to the lenticular sheet over the 3D composite image and may have a cover pressure sensitive backing on one or both sides to which the transparent window cover can be attached to and the frame back attached to the pressure sensitive adhesive area of the backing polymer sheet not covered by the transparent window cover.

### BRIEF DESCRIPTION OF THE DRAWINGS

Other objects, features, and advantages of the present invention will be apparent from the written description and the drawings in which:

FIG. 1 is a front elevation of a picture frame made in accordance with the present invention;

FIG. 2 is a side elevation of the picture frame of FIG. 1;

FIG. 3 is an exploded perspective view of the picture frame of FIGS. 1 and 2; and

FIGS. 4A & 4B is a flow diagram of the process of making a picture frame in accordance with the present invention.

### DESCRIPTION OF THE PREFERRED EMBODIMENT

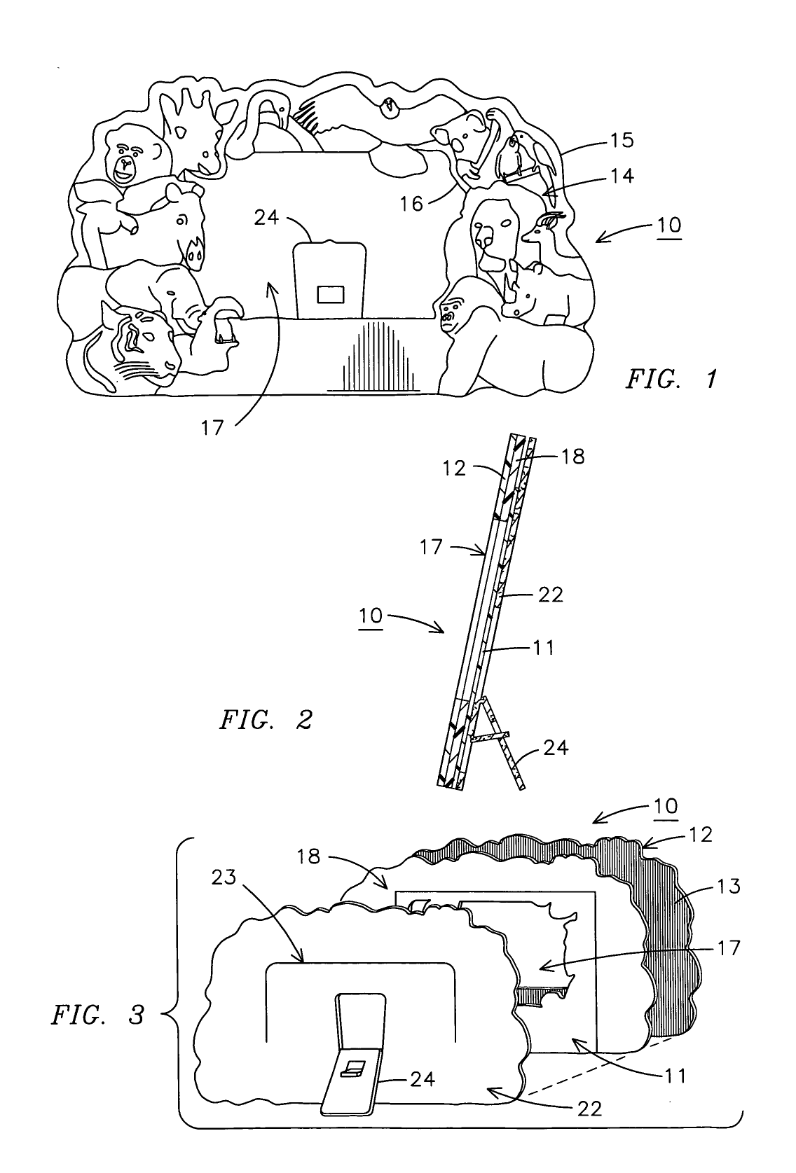

Referring to the drawings and especially to FIGS. 1-3, a picture frame 10 is illustrated having a polymer lenticular front 12 having an image 13 printed on the back thereof. The image 13 works with the lenticular screen to form a 3D image appearance 14, when viewed from the front of the lenticular screen front panel, along the border of the frame 10 which has outside irregular edges 15 and inside edges 16. The border artwork 13 has been printed and applied either directly to the back of the lenticular front panel 12 or printed on a separate sheet and attached to the lenticular front panel 12 in order to provide a three dimensional looking (or 3D) border image. A lenticular 3D image provides a 3D image without having to use an external viewing aid, such as a steroscopic or viewing glasses.

The 3D effect is created by the use of two or more separate images, such as photo images, in which each image is divided into pieces, such as into a plurality of separate columns, and then the separate image columns are interleaved and put together with alternating columns from one image and then the other. When this composite image is mounted to a lenticular screen made up of a plurality of lenses, each positioned over the various interleaved columns, a three dimensional effect is created because each column is being refracted differently through the lens so that one eye line-of-sight sees only one set of strips of one image while the other eye sees only a second set of strips from the interleaved columns of a second image.

The frame 10 has a 3D border artwork 13 and lenticular screen surrounding a cutout window 17. The cutout window has the irregular edges 16 which have been laser cut to follow the patterns of the surrounding image. A supporting polymer panel 18 is attached to the back of the lenticular screen 12 with an adhesive to provide additional support for the thin lenticular screen 12. The panel 18 can be cut with a covered pressure sensitive adhesive (PSA) on both sides thereof for ease in removing the cover and attaching the support panel 18 to the lenticular screen 12. A thin transparent polymer sheet window cover 11 may also be attached over the window 17 and to the backside of the support panel 18 if desired. The back panel 22 may be cut to the same irregular edge pattern as the edge 12 and can be attached to the support panel 18 with an adhesive. The rear panel 22 attaches with adhesive onto the support panel 18. A U-shaped cut 23 in the rear panel 22 can be used to form a pocket in the back frame 22 to allow a picture or photograph to be slid into the frame to fit into the window 17. The back panel 22 has an easel frame stand 24 precut thereinto which can be punched out to support the entire picture frame 10 in a standing position. The finished frame 10 provides a frame with border art 14 which can be of any shape desired and which has a window 17 covered with a thin polymer sheet 11 for placing a picture. The window 17 may have irregular edges 16 therearound and irregular edges 15 around the border art 14 front frame. The image 14 is a three dimensional image provided by lenticular imaging in which the image 13 is an interleaved composite image of two or more images printed on a separate sheet and attached to a lenticular lens or, alternatively, printed directly on the lenticular lens.

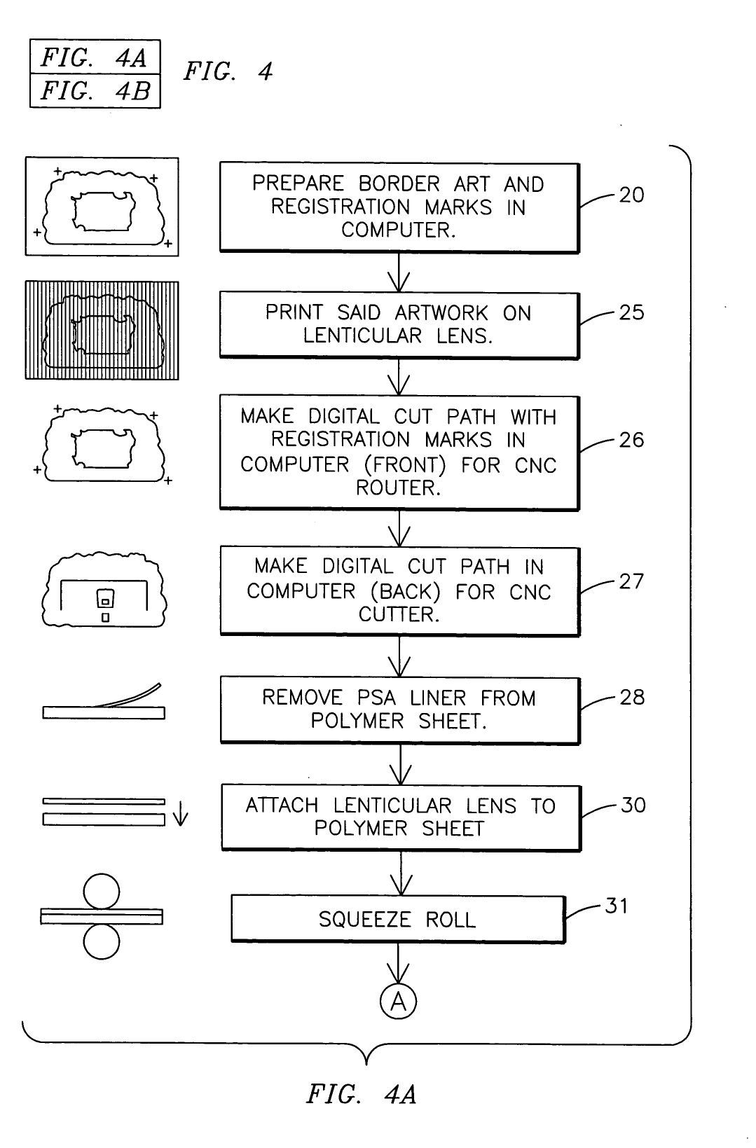

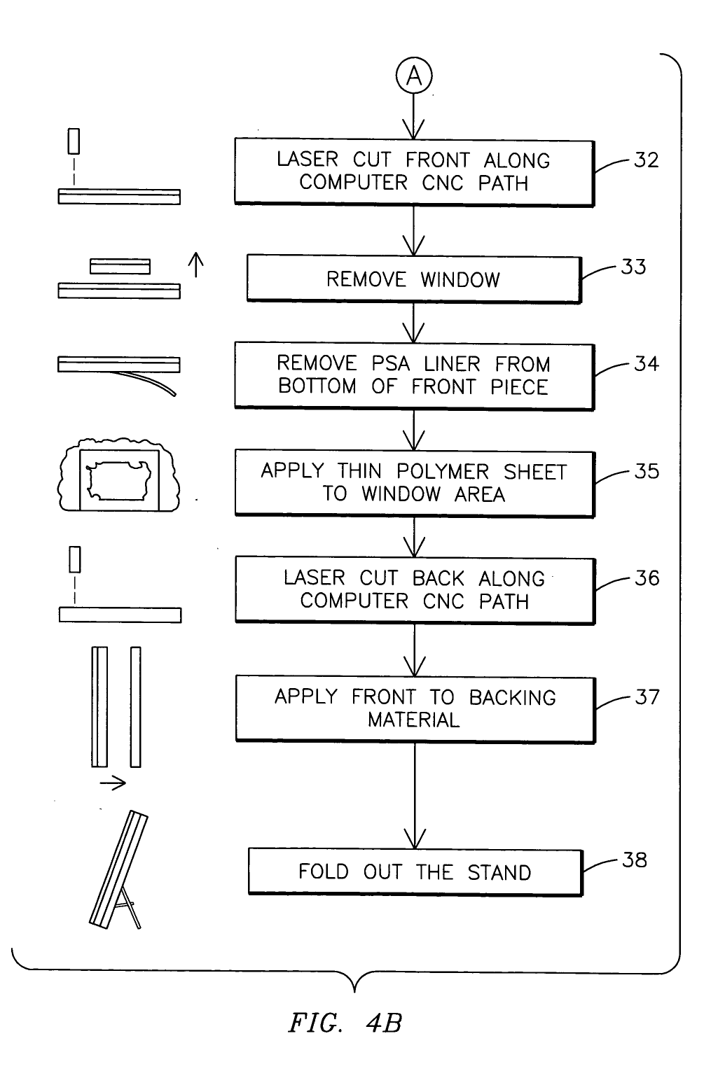

Turning now to FIGS. 4A and 4B, the process of making the frame of FIGS. 1-3 is illustrated starting with the preparation (20) of the 3D border art including registration marks. The artwork is printed (25) directly onto the lenticular lens. The preparation of the 3D art requires a selection of a plurality of images for making the 3D border artwork and dividing each selected image into a plurality of image components, such as a plurality of narrow columns, and interleaving the image components to form a composite border image for 3D viewing through a lenticular sheet. The border art and registration marks may be printed (25) on a paper or a thin sheet of polymer or any material desired but is normally printed on the back of the lenticular sheet. A digital cut path is then made (26) in a computer for cutting the front panel 11 and support panel 18 with a computer numerical cutter (CNC) along a path to follow the outside edge 15 of the artwork 14 and to form a cut path to cut the window 17 along the inside edge 16 of the artwork to form a window inside the border artwork 14. Making (26) a cut path in the front panel is followed by the making (27) of a digital cut path for a computer numerical cutter for the frame back 22. A polymer backing sheet may have a PSA lining on one or both sides for adding support to the thin lenticular front panel and has the PSA liner or cover removed (28). The lenticular lens for the border art is attached (30) to the polymer supporting sheet 18. The attached support sheet and lenticular lens may be squeeze rolled (31) to adhere the pieces together as well as to remove air bubbles to provide a clear view of the artwork 14 through the lenticular polymer front 12.

The process continues with FIG. 4B with the attached panels being laser cut (32) along the computer CNC path for the front panel. Next, the removal (33) of the window may be followed by removing (34) the pressure sensitive adhesive liner or cover from the back of the support panel attached to the lenticular screen panel. A thin transparent polymer sheet may be applied (35) to cover the window 17 and is attached to the back of the support panel 18 but covering only a portion of the pressure sensitive adhesive coating on the back but covering to the bottom edge 23. The back panel 22 is laser cut (36) along the computer marked path with a computer numerical cutter. The back may be cut out of paperboard or a polymer material or any material desired but can be a less expensive material than the lenticular screen attached to the supporting panel of the front to reduce the cost of the overall frame. The laser cut path also has been marked to have the foldout frame stand 24 cut directly into the back panel 22. The back 22 is now applied (37) to the open adhesive covering the back of the support panel 18 such that the outside edges are in alignment. The adhesive in the area surrounding the outside portion of the rear of the support panel 18 attaches to the back panel 22 but leaving unattached an area along the edge 23 with a thin polymer sheet 11 extends to one of the panel edges and covers the adhesive layer to the edge 23. This allows a picture to be inserted between the back 22 and the lenticular sheet 12 and behind the thin polymer sheet 11 to display the picture within the window 17 surrounded by the border art 14. The foldout stand 24 can then be folded (38) out to set up the frame.

It should be clear at this time that a process of making an acrylic or transparent polymer picture frame having a separate backing made of a separate backing material and having a high quality 3D border image on the picture frame having an irregular inside and outside edge has been provided. It should, however, also be clear that the present invention is not to be limited to the forms shown which are to be considered illustrative rather than restrictive.

I claim:

1. A process of making a picture frame having 3D border art work comprising the steps of:
selecting a plurality of images for making a 3D border art work including dividing each selected image into a plurality of image components and interleaving said image components to form a composite border image for 3D viewing through a lenticular sheet;
applying said composite image to a lenticular sheet to thereby form a 3D border image;
marking a cut path in a computer for cutting inner and outer irregular borders in said composite image and lenticular sheet;
marking a cut path in a computer for cutting a back panel for said picture frame;
laser cutting said lenticular sheet having said composite image thereon along said computer marked cut path along the inner and outer borders of said 3D border image to form a window through said lenticular sheet inside said 3D border image;
removing said cutout window formed by said laser cutting of said polymer lenticular sheet along the inner of said 3D border image;
cutting a frame back for said polymer lenticular sheet along said back panel cut path; and
attaching said frame back to said lenticular sheet of material over said 3D border image and window and window covering sheet of polymer material to form a picture frame with a printed 3D decorative border.

2. The process of making a picture frame in accordance with claim 1 including the step of attaching a backing polymer sheet to said lenticular sheet having a composite image thereon and laser cutting said lenticular sheet and attached backing polymer sheet along said computer marked cut path.

3. The process of making a picture frame in accordance with claim 1 in which the step of applying said composite image to a lenticular image applies said composite image directly to said lenticular sheet to thereby create a lenticular image when viewed through said lenticular sheet.

4. The process of making a picture frame in accordance with claim 2 in which the step of attaching a backing polymer sheet to said lenticular sheet includes attaching a backing polymer sheet having a covered pressure sensitive backing on one side thereof.

5. The process of making a picture frame in accordance with claim 2 in which the step of attaching a backing polymer sheet to said lenticular sheet includes attaching a backing polymer sheet having a covered pressure sensitive backing on both sides thereof.

6. The process of making a picture frame in accordance with claim 4 in which the step of attaching said frame back includes removing the cover from said pressure sensitive backing on said backing polymer sheet and adhering said frame back thereto.

7. The process of making a picture frame in accordance with claim 5 includes the steps of attaching a transparent polymer sheet over said window in said polymer lenticular sheet.

8. The process of making a picture frame in accordance with claim 7 in which the step of attaching a transparent window cover includes attaching said transparent window cover to said backing cover sheet pressure sensitive adhesive backing to cover a portion of said adhesive up to one edge of said cut lenticular sheet and backing cover sheet to thereby leave one edge between said frame back and said lenticular sheet and backing cover sheet and attached window sheet unattached for sliding a picture therebetween.

9. The process of making a picture frame in accordance with claim 8 including the step of squeeze rollering said lenticular lens and polymer sheet with PSA backing.

10. The process of making a picture frame in accordance with claim 2 in which the step of cutting a frame back includes cutting a frame back from a sheet of paper board.

11. The process of making a picture frame in accordance with claim 1 including the step of cutting a fold out picture frame stand into said frame back.

12. The process of making a picture frame in accordance with claim 11 including the step of laser cutting a fold out picture frame stand into said frame back.

13. The process of making a picture frame in accordance with claim 4 including the step of sliding a picture between said frame back and said transparent window.

14. The process of making a picture frame in accordance with claim 12 including the step of laser cutting a pocket in said frame back for sliding a picture thereinto.
